(19) United States
(12) Patent Application Publication
(10) Pub. No.: US 2025/0348256 A1
(43) Pub. Date: Nov. 13, 2025

(54) STORAGE MEDIUM STORING PROGRAM FOR SETTING PRINT CONDITION, METHOD FOR SETTING PRINT CONDITION, AND INFORMATION PROCESSING APPARATUS FOR SETTING PRINT CONDITION

(71) Applicant: CANON KABUSHIKI KAISHA, Tokyo (JP)

(72) Inventor: Takashi Horikoshi, Tokyo (JP)

(21) Appl. No.: 19/177,998

(22) Filed: Apr. 14, 2025

(30) Foreign Application Priority Data
May 9, 2024 (JP) 2024-076532

(51) Int. Cl. G06F 3/12; B41J 3/46

(52) U.S. Cl. CPC G06F 3/1253; B41J 3/46; G06F 3/1205; G06F 3/1232; G06F 3/1284

(57) ABSTRACT

A storage medium storing a program capable of reducing an erroneous selection when selecting a print sheet on a setting screen. The storage medium storing a program causing a computer to execute a method for setting a print condition in a printer including a printing unit and a sheet feeding unit. The method includes obtaining first information about sizes of all usable print sheets from the printer, obtaining second information about a size of a print sheet placed on the sheet feeding unit in a sheet feedable state from the printer, obtaining third information about remaining sizes of print sheets obtained by excluding sizes of print sheets larger than the size of the print sheet in the sheet feedable state from the sizes of all the print sheets, and displaying the third information on a setting screen on which the print condition of the printer is set.

### BACKGROUND OF THE INVENTION

### Field of the Invention

The present invention relates to a storage medium storing a program for setting a print condition, a method for setting a print condition, and an information processing apparatus for setting a print condition.

### Description of the Related Art

In recent years, when a print job is transmitted from an information processing apparatus such as a personal computer to a printer (a printing apparatus), a general-purpose printing protocol built in an OS of the information processing apparatus is used without using a dedicated printer driver provided by a vendor, which is a manufacturer of the printer. As an example of the printing protocol (standard protocol), the IPP (Internet Printing Protocol) is known. Between the information processing apparatus and the printer, the printing process is executed by communication according to the IPP. As a capability response of the printer, for example, sheet information including various kinds of information, such as a sheet type, a sheet size, and a sheet feed tray, is constructed, and the sheet information is obtained via the IPP. For example, Japanese Patent Laid-Open Publication No. 2019-123106 (counterpart of U.S. Pat. No. 20200341708 A1) discloses an image forming apparatus that determines whether printing is possible with a print condition set in printing and notifies the user of a determination result when it is determined that printing is impossible.

Some models of printers can use a roll sheet as a print sheet. Further, depending on a model of a printer and a type of an OS, all sheet sizes supported by a printer may be displayed on a print setting screen in print setting. For example, when a printer can use a roll sheet as a print sheet and displays all sheet sizes supported by the printer on a print setting screen, widths of roll sheets is displayed on the print setting screen in addition to all the sheet sizes of cut sheets. In such a print setting screen, even when an A3 roll sheet (roll sheet of which a width is 297 mm) is set in the printer, for example, the user can select an A2-size cut sheet or a roll sheet of which a width is 420 mm that are wider than the A3 roll sheet. When printing is executed in a state where the A2-size cut sheet is selected on the print setting screen even when the A3 roll sheet is set, an image is printed in a size suitable for the A2-size cut sheet, and therefore, there is a problem in that image loss occurs on the A3 roll sheet due to clipping that is not intended by a user.

Further, since the A2-size cut sheet can be selected even when the A3 roll sheet should be selected, there is a possibility that the sheet is erroneously selected on the print setting screen. In addition, the work of replacing an A3 roll sheet with an A2 roll sheet in the printer is not as easy as the work of replacing an A3-size cut sheet with an A2-size cut sheet, for example.

### SUMMARY OF THE INVENTION

The present invention provides a storage medium storing a program, a control method, and an information processing apparatus that are capable of reducing an erroneous selection when selecting a print sheet on a setting screen.

Accordingly, an aspect of the present invention provides a non-transitory computer-readable storage medium storing a program causing a computer to execute a method for setting a print condition in a printer including a printing unit that prints an image on a print sheet and a sheet feeding unit that feeds a print sheet placed thereon to the printing unit, the method including obtaining first information about sizes of all print sheets usable in printing by the printer from the printer, obtaining second information about a size of a print sheet that is placed on the sheet feeding unit in a sheet feedable state, which enables feeding of a sheet to the printing unit, from the printer, obtaining third information about remaining sizes of print sheets obtained by excluding sizes of print sheets larger than the size of the print sheet in the sheet feedable state included in the second information from the sizes of all the print sheets included in the first information, and displaying the third information on a setting screen on which the print condition of the printer is set.

According to the present invention, when a print sheet is selected on the setting screen, an erroneous selection can be reduced.

Further features of the present invention will become apparent from the following description of exemplary embodiments with reference to the attached drawings.

### BRIEF DESCRIPTION OF THE DRAWINGS

FIG. 1 is a block diagram illustrating an example of a hardware configuration and a software configuration of a print system according to a first embodiment.

FIG. 2 is a block diagram illustrating an example of a hardware configuration of a computer in the print system.

FIG. 3 is a block diagram illustrating an example of a hardware configuration of a printer in the print system.

FIG. 4 is a sequence diagram indicating a process executed among a user, a print application, an OS standard print program, and the printer.

FIG. 5 is a flowchart illustrating a process executed by the OS standard print program.

FIG. 6 is a view illustrating first capability information, second capability information, and third information that are respectively listed.

FIG. 7 is a view illustrating an example of a print setting screen displayed on a display unit of the computer.

FIG. 8 is a sequence diagram indicating a process executed among the user, the print application, the OS standard print program, and the printer according to a second embodiment.

FIG. 9 is a flowchart illustrating a process executed by the OS standard print program.

FIG. 10 is a sequence diagram illustrating a process executed among the user, the print application, the OS standard print program, and the printer according to a third embodiment.

FIG. 11 is a view illustrating an example of a print setting screen displayed on the display unit of the computer.

FIG. 12 is a view illustrating the first capability information that is listed.

### DESCRIPTION OF THE EMBODIMENTS

Hereafter, embodiments according to the present invention will be described in detail by referring to the drawings. However, configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added. Any two or more configurations (features) of the embodiments can be combined.

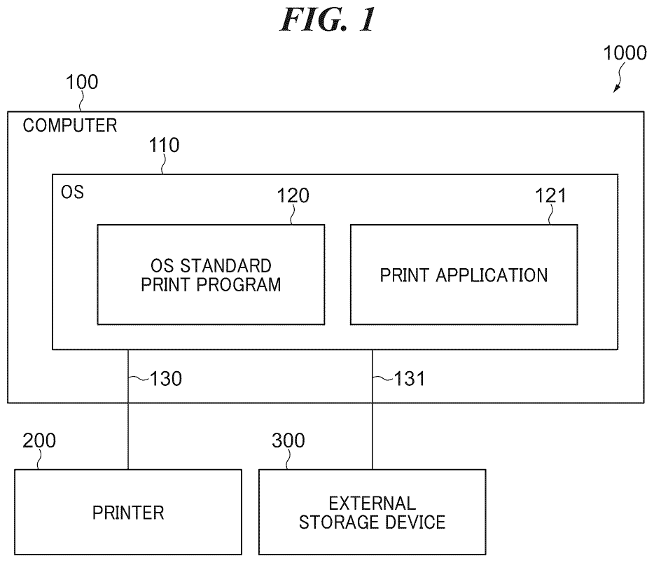

Hereinafter, a first embodiment will be described with reference to FIG. 1 to FIG. 6.

FIG. 1 is a block diagram illustrating an example of a hardware configuration and a software configuration of a print system according to the first embodiment. As shown in FIG. 1, a print system 1000 includes a computer (an information processing apparatus) 100, a printer (a printing apparatus) 200, and an external storage device 300. An OS 110 is installed in the computer 100. The OS 110 includes an OS standard print program 120 and a print application 121. The OS standard print program 120 is software that can be used in common for printers of a plurality of printer makers and is used to control the printer 200.

The OS standard print program 120 is a general-purpose print program provided by the OS 110 of the computer 100. The OS standard print program 120 is a program that generates print data that can be printed by printers of a plurality of printer makers. The print data generated by the OS standard print program 120 is transmitted to the printer 200 in accordance with a protocol such as the Internet Printing Protocol (IPP).

The print application 121 accepts a print setting instruction from a user, and instructs the printer 200 to execute printing via the OS standard print program 120. The print application 121 is not particularly limited, and for example, application programs such as Word and PowerPoint manufactured by Microsoft (registered trademark) or an application program provided by a manufacturer of the printer 200 can be used. The computer 100 is not particularly limited, and for example, an information processing apparatus such as a desktop or notebook personal computer, a tablet terminal, or a smartphone can be used.

The printer 200 is communicably connected to the computer 100 via an interface 130. The external storage device 300 is communicably connected to the computer 100 via an interface 131. A storage device is not limited to the external storage device 300, and may be, for example, an auxiliary storage device or a RAM (Random Access Memory) built in the computer 100, or a RAM built in the printer 200. The external storage device 300 may be an auxiliary storage device or a RAM built in a server (not shown in FIG. 1) on a network. The server may be a server in which the manufacturer of the printer 200 manages information related to the printer 200. Further, each of the interfaces 130 and 131 may be a network interface or a USB interface.

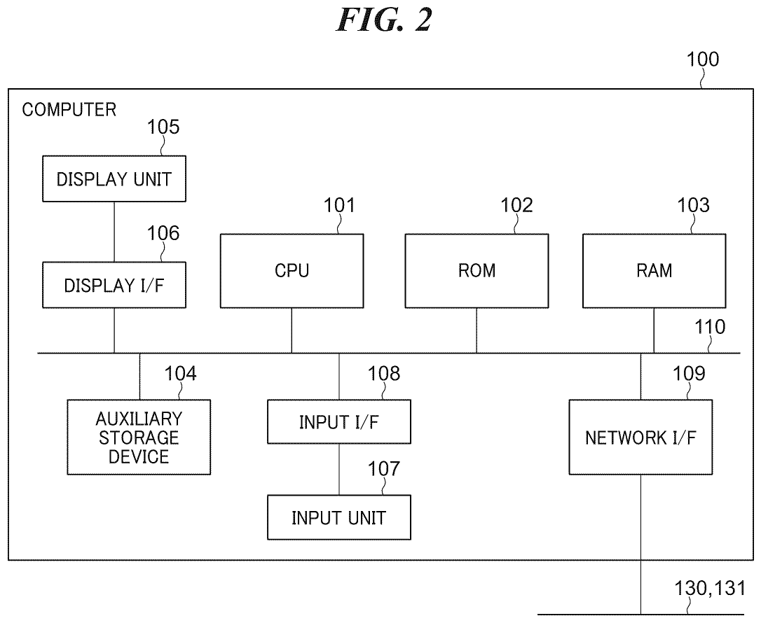

FIG. 2 is a block diagram illustrating an example of a hardware configuration of the computer 100. As shown in FIG. 2, the computer 100 includes a CPU (Central Processing Unit) 101, a ROM (Read Only Memory) 102, a RAM 103, and an auxiliary storage device 104. The computer 100 also includes a display unit 105, a display interface (I/F) 106, an input unit 107, an input I/F 108, and a network I/F 109. The CPU 101, ROM 102, RAM 103, auxiliary storage device 104, display I/F 106, input I/F 108, and network I/F 109 are connected via a bus 110 so as to transmit and receive data mutually.

The CPU 101 controls operations of the entire computer 100. This CPU 101 can execute various processes (control methods) using programs and data stored in the ROM 102 or the auxiliary storage device 104. The ROM 102 stores basic software such as a BIOS used for controlling the computer 100 and setting data unnecessary to be changed. The RAM 103 has an area to store programs and data loaded from the auxiliary storage device 104 and the ROM 102, and various programs and data received from the outside via the network I/F 109. The RAM 103 also has a work area used when the CPU 101 executes various processes.

The auxiliary storage device 104 is a large-capacity information storage device such as a hard disk drive device. The auxiliary storage device 104 stores, for example, an OS, driver software, and various kinds of application software. Usually, the various kinds of application software are installed in the auxiliary storage device 104 by controlling the external storage device 300.

The driver software includes, for example, display control driver software to control a display content on the display unit 105 via the display I/F 106. The driver software includes keyboard driver software to control a keyboard of the input unit 107 via the input I/F 108. The driver software includes pointing device driver software to control a pointing device of the input unit 107 via the input I/F 108. The driver software includes a network driver to control communication via the network I/F 109. The driver software includes driver software to control the printer 200. In the present embodiment, the OS standard print program 120 is initially installed as software to control the printer 200.

The display unit 105 displays, for example, a processing result by the CPU 101 using images and characters. The display unit 105 is not particularly limited, and for example, a CRT, a liquid crystal display, or a projection device (projector) can be used. Further, the display unit 105 may be a touch panel screen having a display function and a user interface function. The input unit 107 can accept input of various kinds of information from an operator (a user) of the computer 100 and issue an instruction to the CPU 101 in accordance with the input information. The input unit 107 is not particularly limited, and for example, a keyboard and a pointing device can be used.

The network I/F 109 performs data communication with an external apparatus. For example, the network I/F 109 may connect to an Internet provider via a communication network, or may communicate data with the printer 200 via the interface 130. The data communication with the printer 200 is not particularly limited, and for example, may be transmission of a print job to the printer 200. It is preferable to use a known method such as mDNS, HTTP, IPP, or TLS for connection to the communication network and security. The network I/F 109 is not particularly limited, and for example, a network board can be used.

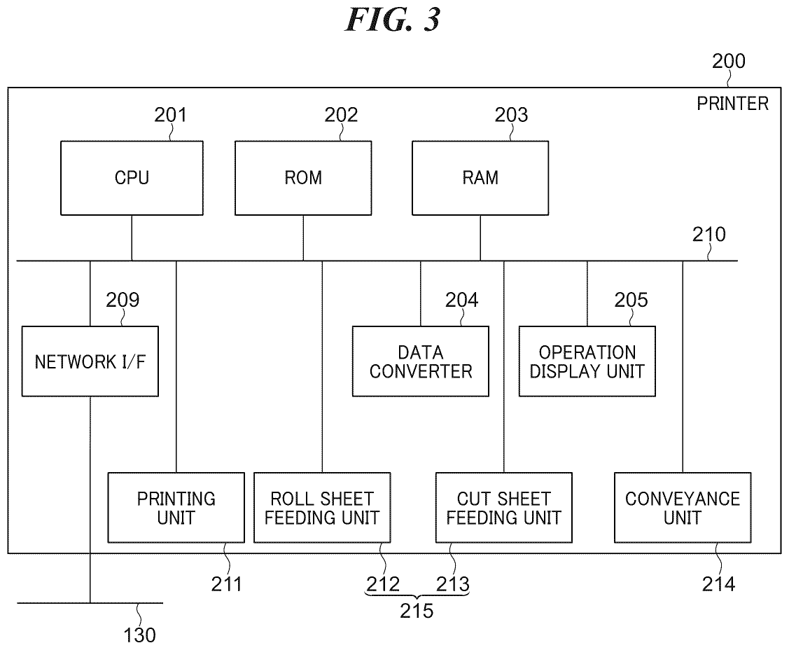

FIG. 3 is a block diagram illustrating an example of a hardware configuration of the printer 200. As shown in FIG. 3, the printer 200 includes a CPU 201, a ROM 202, a RAM 203, a data converter 204, an operation display unit (a display means) 205, and a network I/F 209. The printer 200 includes a printing unit (a printing means) 211, a roll sheet feeding unit 212, a cut sheet feeding unit 213, and a conveyance unit (a conveyance means) 214. These elements of the printer 200 are connected via a bus 210 so as to transmit and receive data mutually.

The CPU 201 is a computer that controls an operation of the printer 200. The ROM 202 stores various programs and data. The programs include, for example, a program for causing the CPU 201 to execute each unit or each means of the printer 200. The RAM 203 has an area to store programs and data loaded from the ROM 202 and various programs and data received from the outside via the network I/F 209. The RAM 203 also has a work area used when the CPU 201 executes various processes.

The data converter 204 analyzes a PDL (Page Description Language) and converts image data such as CG (Computer Graphics) development. The PDL supported by the data converter 204 is, for example, PWG-Raster. The operation display unit 205 displays, for example, a processing result by the CPU 201 using images and characters. In addition, the operation display unit 205 displays various screens such as a menu screen.

As the operation display unit 205, a touch panel screen having a display function and a user interface functions is preferably used. For example, a liquid crystal screen can be used as the screen. Thus, the operation display unit 205 can accept input of various kinds of information from an operator (a user) of the printer 200 and issue an instruction to the CPU 201 in accordance with the input information. The network I/F 209 is an interface that performs data communication with the external apparatus. For example, the network I/F 209 performs data communication with the computer 100 via the interface 130. The data communication with the computer 100 is not particularly limited, and may be, for example, reception of a print job from the computer 100.

The printing unit 211 executes a print job received from the computer 100 via the network I/F 209, thereby prints an image included in the print job on a print sheet (a printing step). The printing method in the printing unit 211 is not particularly limited, and for example, a printing method using ink or a printing method using toner can be used. The print sheet is conveyed from the roll sheet feeding unit 212 or the cut sheet feeding unit 213 to the printing unit 211 (a conveyance step). The conveyance unit 214 performs this conveyance. The conveyance unit 214 includes, for example, a plurality of rollers arranged along a conveyance direction of a print sheet. The print sheet is conveyed by rotation of the rollers. In the present embodiment, a direction orthogonal to the conveyance direction of the print sheet by the conveyance unit 214 is defined as a width direction of the print sheet.

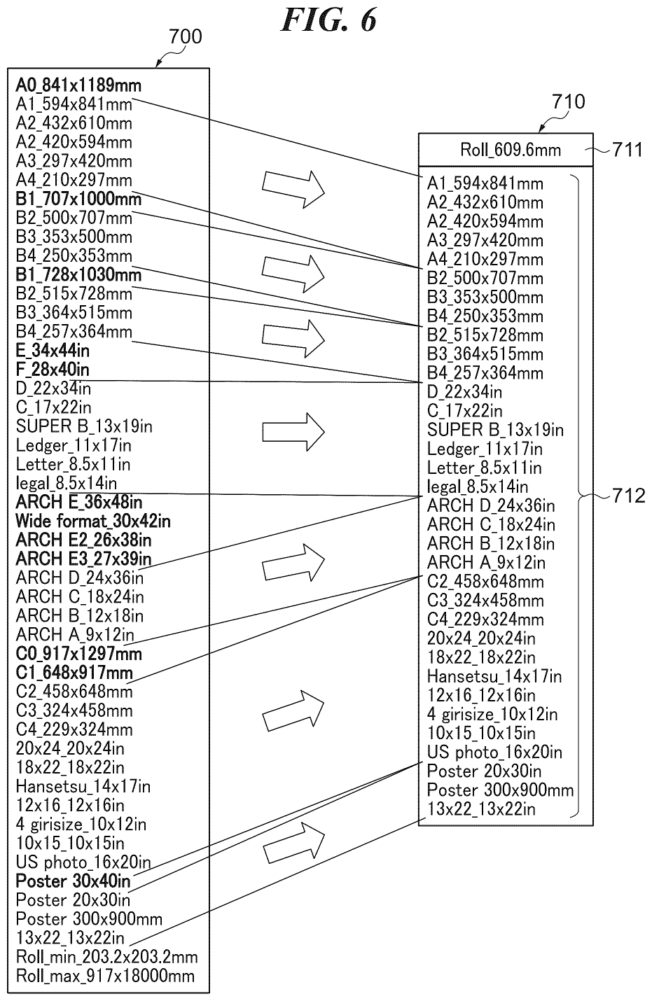

The roll sheet feeding unit 212 to which a roll sheet as a print sheet is set (placed) supplies the roll sheet to the printing unit 211 (a sheet feeding step). A roll sheet is a paper sheet that is wound in a roll shape before printing and is used in a spread state, that is, in a stretched state in printing. In the present embodiment, the roll sheet feeding unit 212 can supply roll sheets of which widths are from 203.2 mm to 917 mm (see a bottom of a list 700 in FIG. 6). The roll sheet feeding unit 212 of the present embodiment allows setting of one size of roll sheet from among a plurality of sizes of roll sheets with different widths, but does not allow setting of a plurality of sizes of roll sheets with different widths all together.

The roll sheet feeding unit 212 preferably includes a roll sheet detection sensor (not shown) that detects whether a roll sheet is set in the roll sheet feeding unit 212, and a roll sheet width sensor (not shown) that detects a width of a roll sheet set to the roll sheet feeding unit 212. The cut sheet feeding unit 213 to which a cut sheet as a print sheet is set supplies the cut sheet to the printing unit 211 (the sheet feeding step). A cut sheet is a paper sheet cut one by one. In the present embodiment, the cut sheet feeding unit 213 can supply at least one of A-size cut sheets and B-size cut sheets, for example. The cut sheet feeding unit 213 of the present embodiment allows setting of a plurality of sizes of cut sheets with different widths together.

The cut sheet feeding unit 213 preferably includes a cut sheet detection sensor (not shown) that detects whether a cut sheet is set to the cut sheet feeding unit 213, and a cut sheet width sensor (not shown) that detects a width of the cut sheet set to the cut sheet feeding unit 213. In this way, the printer 200 has a sheet feeding unit (a sheet feeding means) 215 that includes the roll sheet feeding unit 212 and the cut sheet feeding unit 213 that can respectively supply a roll sheet and a cut sheet to the printing unit 211.

In printing, either the roll sheet set to the roll sheet feeding unit 212 or the cut sheet set to the cut sheet feeding unit 213 is selected. This selection is made on an operation screen (not shown) displayed on the operation display unit 205. Hereinafter, a state in which the print sheet is placed on the sheet feeding unit 215 and can be supplied to the printing unit 211 may be referred to as a “sheet feedable state”. As described above, the roll sheet feeding unit 212 does not allow setting of a plurality of sizes of roll sheets with different widths all together in the present embodiment, this is not limiting. For example, the roll sheet feeding unit 200 may allow setting of a plurality of sizes of roll sheets with different widths together. In this case, one size of a roll sheet is selected from among the plurality of sizes of roll sheets in printing.

Next, the operation of the print system will be described. The computer 100 displays the print setting screen (a setting screen) for setting print conditions in the printer 200 on the display unit 105 (a display step). This display control is performed via the display I/F 106. As described above, in the printer 200, either the roll sheet set to the roll sheet feeding unit 212 or the cut sheet set to the cut sheet feeding unit 213 is selectable as a print sheet. In this case, items of the sizes of all print sheets usable in printing in the printer 200, that is, widths of the sizes of all printable roll sheets and the sizes of all printable cut sheets may be displayed on the print setting screen. On such a print setting screen, even when, for example, an A3 roll sheet (a roll sheet of which a width is 297 mm) is set in the printer 200, a user can select an A2-size cut sheet of which a width is wider than the A3 roll sheet. When printing is executed in a state where the A2-size cut sheet is selected on the print setting screen even when the A3 roll sheet is set, an image is printed in a size suitable for the A2-size cut sheet, and therefore, there is a problem in that image loss occurs on the A3 roll sheet due to clipping that is not intended by a user. Further, since the A2-size cut sheet can be selected even when the A3 roll sheet should be selected, there is a possibility that the sheet is erroneously selected on the print setting screen. In addition, the work of replacing an A3 roll sheet with an A2 roll sheet in the printer 200 is not as easy as the work of replacing an A3-size cut sheet with an A2-size cut sheet.

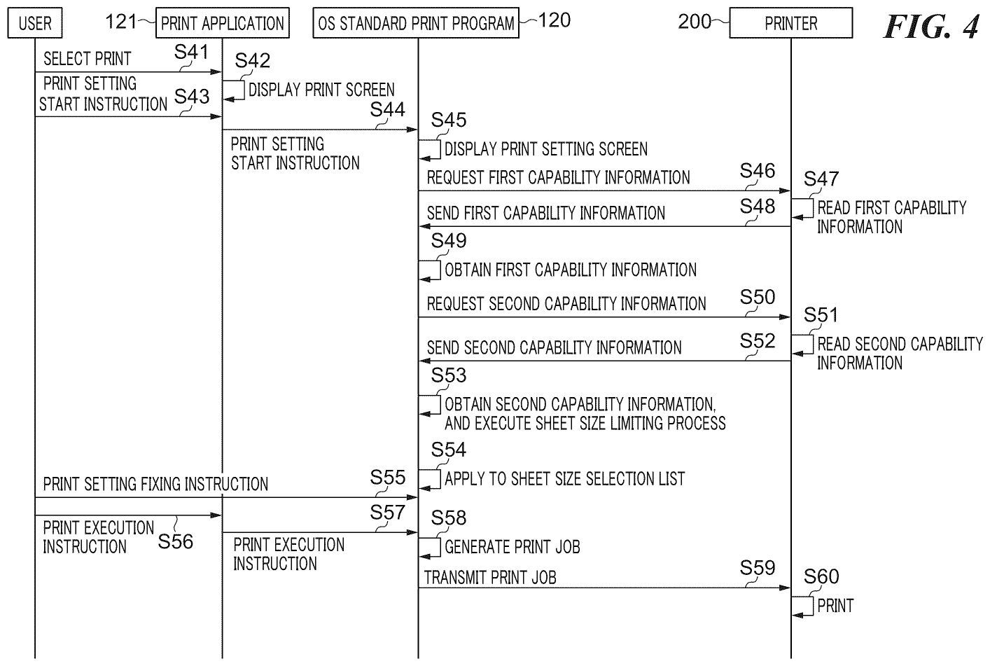

Therefore, the printer 200 is configured to be able to reduce the occurrence of such a phenomenon (state). This configuration and its effect will be described below. FIG. 4 is a sequence diagram indicating a process executed among the user, the print application, the OS standard print program, and the printer. As shown in FIG. 4, in a step S41, the user selects print execution to the printer 200 using a print function of the print application 121.

In a step S42, the print application 121 accepts the instruction of the print execution selected in the step S41 and displays a print screen on the display unit 105. The print application 121 can accept a print setting start instruction, a print setting fixing instruction, and a print execution instruction on the print screen.

In a step S43, the user inputs the print setting start instruction on the print screen displayed in the step S42 on the display unit 105.

In a step S44, the print application 121 accepts the print setting start instruction input in the step S43 and issues the print setting start instruction to the OS standard print program 120.

In a step S45, the OS standard print program 120 accepts the print setting start instruction issued in the step S44 and displays the print setting screen on the display unit 105.

In a step S46, the OS standard print program 120 requests first capability information (first information) from the printer 200 via the interface 130. The first capability information includes information relating to the sizes of all the print sheets (in particular, the widths of the sizes of all the print sheets in the present embodiment) usable in printing in the printer 200. Information about a sheet size includes numerical values indicating a sheet width and a sheet height (a total sheet length). The sheet height of a roll sheet is a combination of values of the minimum height and the maximum height. The first capability information also includes information about all sheet feeding methods supported by the printer 200 and information about print resolutions supported by the printer 200. Note that communication between the OS standard print program 120 and the printer 200 is performed in accordance with a communication protocol, such as the IPP, of the OS 110.

In a step S47, the printer 200 receives the request of the first capability information sent in the step S46 and reads the first capability information from the RAM 203. As a result, preparation of a response of the first capability information to the OS standard print program 120 is completed. The first capability information is not necessarily read from the RAM 203.

In a step S48, the printer 200 sends the first capability information read in the step S47 to the OS standard print program 120.

In a step S49, the OS standard print program 120 obtains the first capability information sent from the printer 200 in the step S48 (an obtaining step). In this way, in the present embodiment, the OS standard print program 120 is capable of performing a first capability information obtaining control to obtain the first capability information. The first capability information is stored in the RAM 103, for example.

In a step S50, the OS standard print program 120 requests second capability information (second information) from the printer 200 via the interface 130.

In a step S51, the printer 200 receives the request to obtain the second capability information sent in the step S50 and reads the second capability information from the RAM 203. As a result, preparation of a response of the second capability information to the OS standard print program 120 is completed. The second capability information is not necessarily read from the RAM 203. For example, the second capability information may be obtained based on the detection results of the cut sheet detection sensor and the cut sheet width sensor described above. The second capability information includes information about the size of the print sheet in the sheet feedable state in the printer 200 (the width of the roll sheet selected in the roll sheet feeding unit 212 in particular in the present embodiment).

In a step S52, the printer 200 sends the second capability information read in the step S51 to the OS standard print program 120.

In a step S53, the OS standard print program 120 obtains the second capability information sent from the printer 200 in the step S52 (the obtaining step) and then executes a sheet size limiting process to make a list of selectable sheet sizes. The sheet size limiting process will be described later. In this way, in the present embodiment, the OS standard print program 120 is capable of performing a second capability information obtaining control to obtain the second capability information. The second capability information is stored in the RAM 103, for example.

In a step S54, the OS standard print program 120 applies a list of selectable sheet sizes made in the sheet size limiting process in the step S53 to a sheet size selection list on the print setting screen.

In a step S55, the user issues the print setting fixing instruction on the print screen displayed in the step S42 on the display unit 105. As a result, the OS standard print program 120 accepts the print setting fixing instruction. Thereafter, the OS standard print program 120 closes the print setting screen to which the result of the sheet size limiting process in the step S53 is reflected.

In a step S56, the user issues the print execution instruction (execution of a print job) on the print screen displayed in the step S42 on the display unit 105.

In a step S57, the print application 121 accepts the print execution instruction issued in the step S56 and notifies the OS standard print program 120 of the print execution instruction. The print execution instruction includes image data information to be printed and print setting information.

In step S58, the OS standard print program 120 generates a print job based on the print execution instruction notified in the step S57.

In a step S59, the OS standard print program 120 transmits the print job generated in the step S58 to the printer 200.

In a step S60, the printer 200 receives the print job transmitted in the step S59 and executes printing based on the print job.

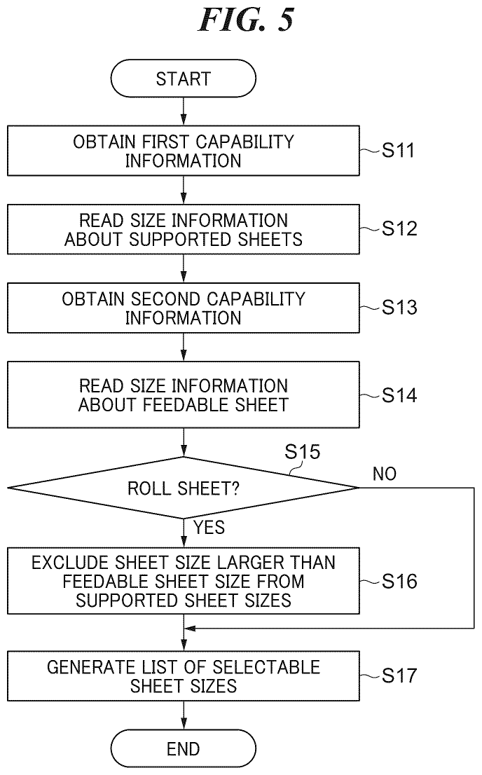

FIG. 5 is a flowchart illustrating a process executed by the OS standard print program. As shown in FIG. 5, in a step S11, the OS standard print program 120 obtains the first capability information from the printer 200. This step S11 corresponds to the obtainment of the first capability information in the step S49 in the sequence diagram shown in FIG. 4.

In a step S12, the OS standard print program 120 reads size information about the sizes of all print sheets that can be used in printing by the printer 200, i.e., that are supported by the printer 200, from the first capability information obtained in the step S11.

In a step S13, the OS standard print program 120 obtains the second capability information from the printer 200. This step S13 corresponds to the obtainment of the second capability information in the step S53 in the sequence diagram shown in FIG. 4.

In a step S14, the OS standard print program 120 reads the size information about the print sheet that is currently in the sheet feedable state in the printer 200 from the second capability information obtained in the step S13.

In a step S15, the OS standard print program 120 determines whether the print sheet currently in the sheet feedable state in the printer 200 is a roll sheet based on the size information about the print sheet in the sheet feedable state read in the step S14. As a result of the determination in the step S15, it is determined that the print sheet is a roll sheet, the process proceeds to a step S16. On the other hand, as a result of the determination in the step S15, it is determined that the print sheet is not a roll sheet, the process proceeds to a step S17.

In the step S16, the OS standard print program 120 obtains third information based on the size information about the sizes of all the print sheets read in the step S12 and the size information about the print sheet in the sheet feedable state read in the step S14. The third information relates to the sizes of remaining sizes of print sheets obtained by excluding the sizes larger than the size of the print sheet in the sheet feedable state (in the present embodiment, the size of the roll sheet) from the sizes of all the print sheets. The size of the roll sheet shall be “Roll_609.6 mm” as an example (see a list 710 in FIG. 6). In the printer 200, the roll sheet of the size of “Roll_609.6 mm” is set in roll sheet feeding unit 212 in the sheet feedable state. The third information is stored in the RAM 103, for example. The step S16 corresponds to the sheet size limiting process in the step S53 in the sequence diagram shown in FIG. 4.

In the step S17 (control to display the third information on the print setting screen), the OS standard print program 120 generates a list of size information about the sizes of print sheets that are currently selectable in the printer 200. The step S17 corresponds to the applying of the sheet size selection list in the step S54 in the sequence diagram shown in FIG. 4.

In other words, prior to the step S17, it is determined in the step S16 whether the sizes of all print sheets included in the first capability information includes a size larger than the size of the print sheet (here, the roll sheet) in the sheet feedable state included in the second capability information. Then, as a result of the determination of the presence or absence, when it is determined that there is a larger size, the process in the step S17 (generation of a list of size information of the print sheets that are currently selectable in the printer 200) undergoing the sheet size limiting process is executed. On the other hand, as a result of the determination of the presence or absence, when it is determined that there is no larger size, the process in the step S17 undergoing the sheet size limiting process is omitted. Note that the first capability information may be displayed on the print setting screen instead of omitting the process in the step S17 undergoing the sheet size limiting processing.

FIG. 6 is a view illustrating the first capability information, second capability information, and third information that are respectively listed. The list 700 shown in FIG. 6 lists the size information (first capability information) about the sizes of all print sheets that can be used in printing by the printer 200. The list 700 includes cut sheets of sizes from “A0_841×1189 mm” to “13×22_13×22 in” as the sizes of all the print sheets. Furthermore, the list 700 also includes the roll sheets of sizes from “Roll_min_203.2×203.2 mm” to “Roll_max_917×18000 mm”. In the list 700, the sizes (the second capability information) larger than the size “Roll_609.6 mm” of the roll sheet are indicated in bold. The list 710 shown in FIG. 6 represents the third information. The list 710 lists the remaining sizes of print sheets obtained by excluding the sizes larger than the size “Roll_609.6 mm” of the roll sheet from the sizes in the list 700. This listed information is generated by the CPU 101. Note that “Roll_609.6 mm” falls within the range from “Roll_min_203.2×203.2 mm” to “Roll_max_917×18000 mm”.

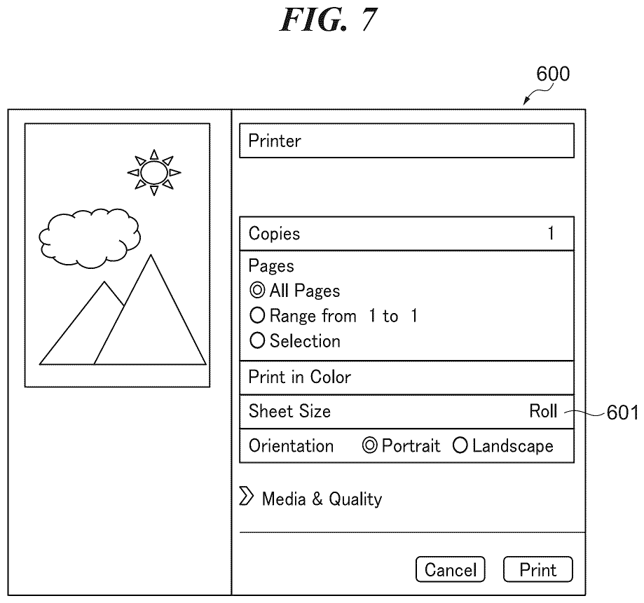

FIG. 7 is a view illustrating an example of the print setting screen displayed on the display unit 105 of the computer 100. FIG. 7 shows a print setting screen 600 used to set a print condition in the printer 200. The print setting screen 600 includes an operation column 601. In the operation column 601, the user can perform an operation to select a desired print sheet to be used in printing. By operating, that is, pressing the operation column 601, the list 710 shown in FIG. 6 is displayed as a pop-up menu. For example, the user can select the size of “Roll_609.6 mm” as a selection item 711 (FIG. 6) from among the sizes included in the list 710. The selection item 711 is preferably displayed in reverse or highlighted, for example. Accordingly, the selection item 711 is emphasized, and it is possible to easily grasp which size is selected.

In the list 710, the remaining items 712 other than the selected item 711 are items of sizes smaller than the size of “Roll_609.6 mm”. Then, when the operation on the operation column 601 is released, “Roll” indicating that the roll sheet of the size of “Roll_609.6 mm” is selected is displayed in the operation column 601. In the step S17 undergoing the process in the step S16 (the sheet size limiting process), as described above, the list 710 is displayed as a pop-up menu in the operation column 601. On the other hand, when the process in the step S17 is skipped, the list 700 is displayed as a pop-up menu in the operation column 601 in the step S17.

As described above, on the print setting screen 600, the third information regarding the remaining sizes of print sheets excluding the sizes larger than the size of the print sheet in the paper feedable state included in the second capability information from the sizes of all the print sheets included in the first capability information can be listed and displayed. This can suppress a phenomenon (state) in which, when print sheet is selected on the print setting screen 600, the A2-size cut sheet can be selected although the A3 roll sheet should be selected as described above. This can reduce the erroneous selections on the print setting screen. Further, the image loss due to clipping, and the replacement of the print sheets can be reduced. When there is a possibility that an image loss occurs, it is preferable to notify the user of the possibility.

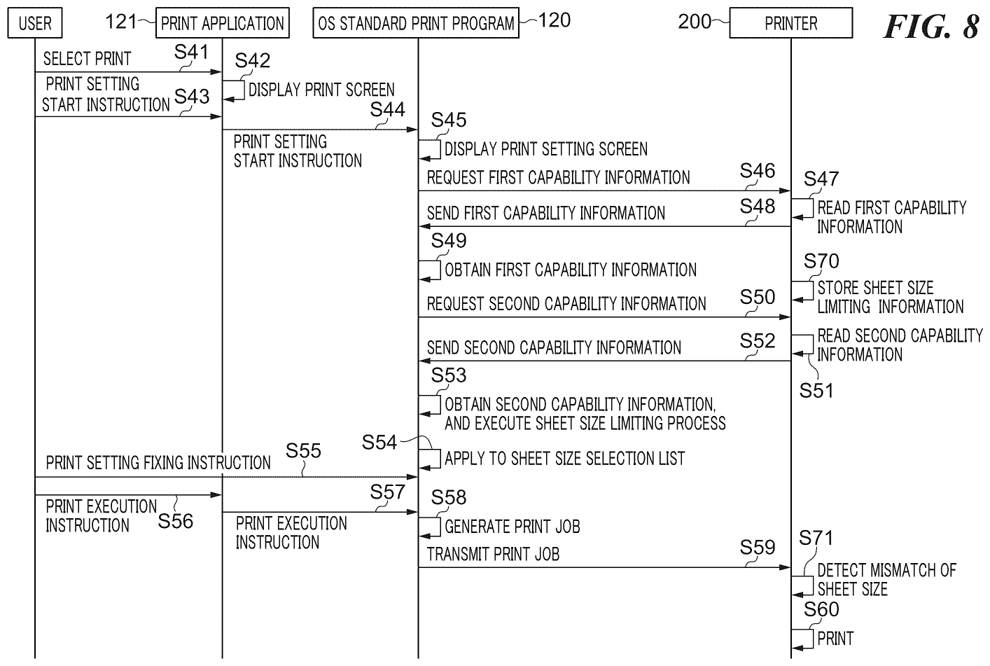

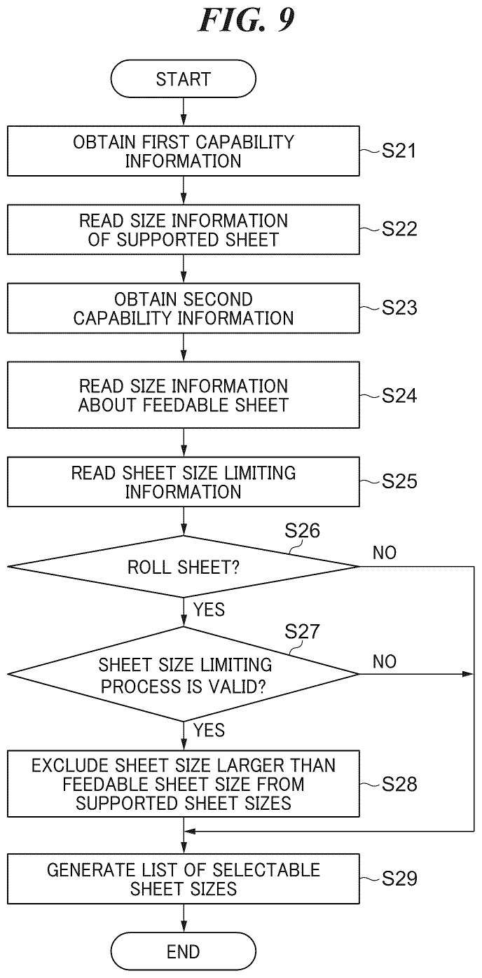

Hereinafter, a second embodiment will be described with reference to FIG. 8 and FIG. 9. The description will focus on differences from the above-described embodiment, and the description of the same matters will be omitted.

FIG. 8 is a sequence diagram indicating a process executed among the user, the print application, the OS standard print program, and the printer according to the second embodiment. In the sequence illustrated in FIG. 8, unlike the sequence illustrated in FIG. 4, the printer 200 further executes a step S70 and a step S71. The step S70 is executed between the steps S48 and S50. In this step S70, the printer 200 accepts and stores the setting of validity or invalidity of the sheet size limiting process (sheet size limiting information). In this case, on the print setting screen 600, validity or invalidity of the display of the list 710 (the sheet size limiting process) is selectable. When the validity of the display of the list 710 is selected, the printer 200 accepts and stores the setting of validity of the sheet size limiting process. On the other hand, when the invalidity of the display of the list 710 is selected, the setting of invalidity of the sheet size limiting process is accepted and stored.

The step S71 is executed between the steps S59 and S60. In the step S71, the printer 200 determines whether the size of the print sheet used in the execution of the print job matches the size of the print sheet in the sheet feedable state in the printer 200 (a sheet size mismatch detection function). As a result of the determination, when it is determined that the two sizes match, the process proceeds to the step S60. On the other hand, when it is determined that the two sizes do not match, it is preferable to stop the execution of the step S60 and to notify the user of the stop.

FIG. 9 is a flowchart illustrating a process executed by the OS standard print program. In the flowchart shown in FIG. 9, steps S21 to S24 are sequentially executed. The steps S21 to S24 are respectively similar to the steps S11 to S14 in the flowchart shown in FIG. 5. After executing the step S24. the process proceeds to a step S25. In the step S25, the OS standard print program 120 read sheet size limiting information. This information includes at least a sheet type that distinguishes a sheet is a cut sheet or a roll sheet, and a value of a sheet width.

After executing the step S25, the process proceeds to a step S26. The step S26 is similar to the step S15 in the flowchart shown in FIG. 5. As a result of the determination in the step S26, when it is determined that the print sheet is a roll sheet, the process proceeds to a step S27. On the other hand, as a result of the determination in the step S26, it is determined that the print sheet is not a roll sheet, the process proceeds to a step S29.

In the step S27, the OS standard print program 120 determines whether the sheet size limiting process is valid. As a result of the determination in the step S27, when it is determined that the sheet size limiting process is valid, the process proceeds to a step S28. On the other hand, as a result of the determination in the step S27, when it is determined that sheet size limiting process is not valid, that is, invalid, the process proceeds to the step S29. The steps S28 and S29 are respectively similar to the steps S16 and S17 in the flowchart shown in FIG. 5.

In the present embodiment as described above, when the sheet size mismatch detection function is set to be valid, the OS standard print program accepts the valid state of the sheet size limiting process and executes the sheet size limiting process. Then, the OS standard print program can restrict a selection on the print setting screen to select a print sheet of which a size is larger than the width of the roll sheet in the sheet feedable state in the printer 200. This can prevent a user from selecting a wrong size of a print sheet.

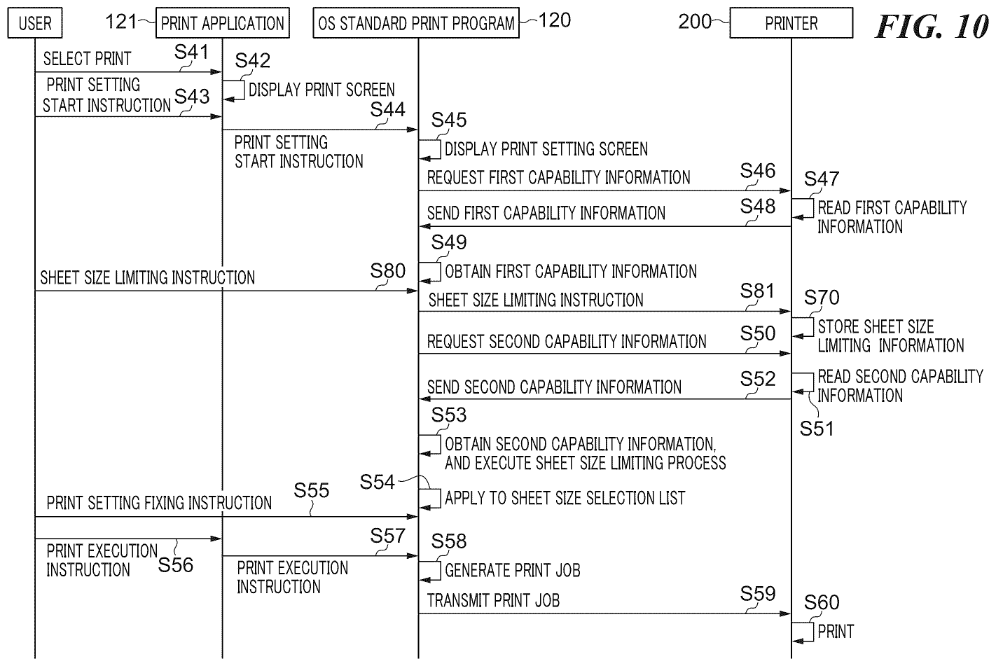

Hereinafter, a third embodiment will be described with reference to FIG. 10 to FIG. 12. The description will focus on differences from the above-described embodiments, and the description of the same matters will be omitted.

FIG. 10 is a sequence diagram illustrating a process executed among the user, the print application, the OS standard print program, and the printer according to a third embodiment. In the sequence illustrated in FIG. 10, unlike the sequence illustrated in FIG. 8, the user further executes a step S80, and the OS standard print program 120 further executes a step S81. In addition, in the sequence illustrated in FIG. 10, unlike the sequence illustrated in FIG. 8, the step S71 is omitted. The steps S80 and S81 are executed between the step S49 and the step S70. In the step S80, the user issues a sheet size limiting instruction on the print screen displayed on the display unit 105 in the step S42. Accordingly, the OS standard print program 120 accepts the sheet size limiting instruction. In the step S81, the OS standard print program 120 transmits the sheet size limiting instruction to validate the sheet size limiting process to the printer 200.

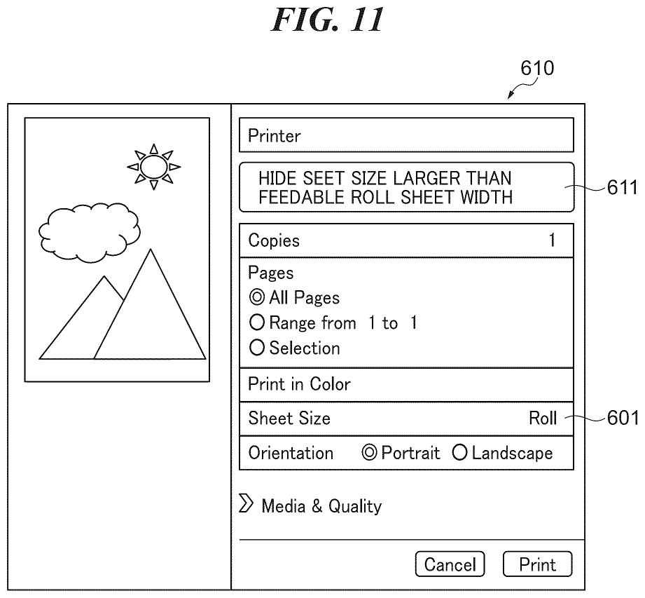

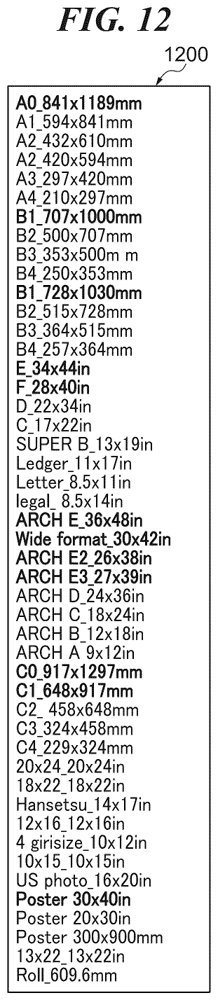

FIG. 11 is a view illustrating an example of a print setting screen displayed on the display unit of the computer. FIG. 12 is a view illustrating the first capability information that is listed. The print setting screen 610 shown in FIG. 11 further includes a button 611 in addition to the operation column 601. The button 611 is used to set whether to display a print sheet size larger than the width of the roll sheet in the sheet feedable state. As an example in FIG. 11, the button 611 is set to hide a print sheet size larger than the width of the roll sheet in the sheet feedable state. In contrast, when the button 611 is set to display a print sheet size larger than the width of the roll sheet in the sheet feedable state, a list 1200 shown in FIG. 12 is displayed as a pop-up menu.

The list 1200 includes size information about sizes of all print sheets that can be used in printing by the printer 200. In particular, the list 1200 includes cut sheets of sizes from “A0_841×1189 mm” to “13×22_13×22 in” and a roll sheet of a size “Roll_609.6 mm”. In the present embodiment as described above, for example, the operation of the button 611 and the sheet size limiting information can be linked. Accordingly, displaying and hiding of the list of the size information about the sizes of all the print sheets that can be used in printing by the printer 200 can be switched on the print setting screen 610.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-076532, filed May 9, 2024, which is hereby incorporated by reference herein in its entirety.

What is claimed is:

1. A non-transitory computer-readable storage medium storing a program causing a computer to execute a method for setting a print condition in a printer including a printing unit that prints an image on a print sheet and a sheet feeding unit that feeds a print sheet placed thereon to the printing unit, the method comprising:
obtaining first information about sizes of all print sheets usable in printing by the printer from the printer;
obtaining second information about a size of a print sheet that is placed on the sheet feeding unit in a sheet feedable state, which enables feeding of a sheet to the printing unit, from the printer;
obtaining third information about remaining sizes of print sheets obtained by excluding sizes of print sheets larger than the size of the print sheet in the sheet feedable state included in the second information from the sizes of all the print sheets included in the first information; and
displaying the third information on a setting screen on which the print condition of the printer is set.

2. The non-transitory computer-readable storage medium according to claim 1, wherein a list of the third information is generated as the third information to be displayed on the setting screen.

3. The non-transitory computer-readable storage medium according to claim 1, wherein information about a pint sheet of which a size is larger than the size of the print sheet in the sheet feedable state included in the second information among the sizes of all print sheets included in the first information is displayed on the setting screen.

4. The non-transitory computer-readable storage medium according to claim 1, wherein when a direction orthogonal to a conveyance direction in which the print sheet in the paper feedable state is conveyed from the paper feeding unit is defined as a width direction of the print sheet, the first information includes widths of all the print sheets, and the second information includes a width of the print sheet in the sheet feedable state.

5. The non-transitory computer-readable storage medium according to claim 4, wherein one of a cut sheet and a roll sheet is selected in the sheet feeding unit as the print sheet that is feedable to the printing unit, and
wherein the second information relates to a width of the roll sheet.

6. The non-transitory computer-readable storage medium according to claim 1, wherein the method further comprises determining presence or absence of a size larger than the size of the print sheet in the sheet feedable state included in the second information among the sizes of all the print sheets included in the first information prior to a control of displaying the third information on the setting screen.

7. The non-transitory computer-readable storage medium according to claim 6, wherein the third information is displayed on the setting screen when the presence is determined as a result of determination, and
wherein the third information is not displayed when the absence is determined.

8. The non-transitory computer-readable storage medium according to claim 7, wherein the first information is displayed on the setting screen when the absence is determined.

9. The non-transitory computer-readable storage medium according to claim 1, wherein valid and invalid of display of the third information on the setting screen is selectable, and
wherein the third information is displayed on the setting screen when the valid of display of the third information on the setting screen is selected.

10. The non-transitory computer-readable storage medium according to claim 1, wherein the method further comprises determining whether a size of a print sheet used in a print job executed by the printing unit matches the size of the print sheet in the sheet feedable state.

11. The non-transitory computer-readable storage medium according to claim 1, wherein the first information, the second information, and the third information are stored in the computer.

12. The non-transitory computer-readable storage medium according to claim 1, wherein The program can be used in common for printers of a plurality of printer makers.

13. A method for setting a print condition in a printer including a printing unit that prints an image on a print sheet and a sheet feeding unit that feeds a print sheet placed thereon to the printing unit, the method comprising:
obtaining first information about sizes of all print sheets usable in printing by the printer from the printer;
obtaining second information about a size of a print sheet that is placed on the sheet feeding unit in a sheet feedable state, which enables feeding of a sheet to the printing unit, from the printer;
obtaining third information about remaining sizes of print sheets obtained by excluding sizes of print sheets larger than the size of the print sheet in the sheet feedable state included in the second information from the sizes of all the print sheets included in the first information; and
displaying the third information on a setting screen on which the print condition of the printer is set.

14. An information processing apparatus for setting a print condition in a printer including a printing unit that prints an image on a print sheet and a sheet feeding unit that feeds a print sheet placed thereon to the printing unit, the information processing apparatus comprising:
a memory device that stores a set of instructions; and
at least one processor that executes the set of instructions to:
obtain first information about sizes of all print sheets usable in printing by the printer from the printer;
obtain second information about a size of a print sheet that is placed on the sheet feeding unit in a sheet feedable state, which enables feeding of a sheet to the printing unit, from the printer;
obtain third information about remaining sizes of print sheets obtained by excluding sizes of print sheets larger than the size of the print sheet in the sheet feedable state included in the second information from the sizes of all the print sheets included in the first information; and
display the third information on a setting screen on which the print condition of the printer is set.
